(19) United States
(12) Patent Application Publication
(10) Pub. No.: US 2026/0128977 A1
(43) Pub. Date: May 7, 2026

(54) METHODS, SYSTEMS, AND COMPUTER READABLE MEDIA DISCOVERING EQUAL COST MULTI-PATH (ECMP) ROUTING PATHS IN NETWORK TOPOLOGY USING ENHANCED TRACEROUTE

(71) Applicant: Keysight Technologies, Inc., Santa Rosa, CA (US)

(72) Inventors: Manomugdha Biswas, Kolkata (IN); Ajay Ramamurthy, Bangalore (IN); Anirban Bhattacharya, Kolkata (IN)

(21) Appl. No.: 19/038,900

(22) Filed: Jan. 28, 2025

(30) Foreign Application Priority Data
Nov. 7, 2024 (IN) 202411085452

(51) Int. Cl. H04L 43/12; H04L 43/065; H04L 43/50

(52) U.S. Cl. CPC H04L 43/12; H04L 43/065; H04L 43/50

(57) ABSTRACT

A method for discovering network paths using an enhanced traceroute procedure includes generating probe request packets addressed to a destination node and each being associated with an entropy value that is unique to a packet flow and a signature value that is unique to the probe request packet within the packet flow. The TTL values in the probe request packets for the packet flow are set to incrementally increasing values. The probe request packets are transmitted to a next-hop, where multiple probe request packets with different TTL are outstanding for a given flow. The method further includes receiving probe response packets that each encapsulate one of the probe request packets. The method further includes reading, from the probe response packets, the signature values and using the signature values to determine a topology of hops including positions of the hops in a path from the source node to the destination node.

### PRIORITY CLAIM

This application claims the priority benefit of Indian Patent Application Number 202411085452, filed Nov. 7, 2024, the disclosure of which is incorporated herein by reference in its entirety.

### TECHNICAL FIELD

The subject matter described herein relates to network topology discovery. More particularly, the subject matter described herein relates to methods, systems, and computer readable media for discovering ECMP paths in a network topology using an enhanced traceroute procedure BACKGROUND

ECMP is a routing strategy where multiple equal cost routing paths exist between a source and a destination. In an ECMP routing strategy, routers between the source and the destination are referred to as hops. At each hop between the source and the destination, a router must make a per-hop routing decision as to which path to use to forward traffic. Mapping and debugging network topologies with increasing numbers of ECMP paths at each router can be complex.

Traceroute is a utility available in most computer operating systems that can be used to discover network hops between a source and a destination by sending Internet control management protocol (ICMP) echo request packets with incrementally increasing time to live values (TTL) towards the destination. When a router receives an ICMP echo request packet, the router determines if the TTL value is greater than 1. If the TTL value is greater than 1, the router decrements the TTL value in the packet and forwards the packet to a next-hop router in a path towards the destination or to the destination if the destination is the next hop. If the TTL value in a received ICMP echo request packet is equal to 1, the router responds to the ICMP echo request packet with an ICMP time exceeded in transit message indicating that the TTL value in the packet became zero before the packet reached the destination. By incrementally increasing the TTL values in successive ICMP messages, a sending node can discover a number of hops between a source and a destination. However, while conventional traceroute gives hop information, it does not provide information as to how hops are connected to each other. As a result, conventional traceroute does not provide a complete view of a network topology. In addition, in some conventional traceroute implementations, a probe request is sent, and the sender waits for a probe response before sending the next probe request with an incremented TTL value. Such an implementation may result in unacceptable delays in discovering network topologies in networks with large numbers of hops and/or paths.

Accordingly, in light of these and other difficulties, there exists a need for improved methods, systems, and computer readable media for network topology discovery.

### SUMMARY

A method for discovering network paths using an enhanced traceroute procedure is described. Although the method is referred to as an enhanced traceroute procedure, in one implementation, the method may not use any native traceroute code on the sending node. Instead, the method uses code that generates ICMP echo request packets and receives ICMP response packets (like traceroute) but uses a unique per packet, per flow signature value in the ICMP echo request packets that are encapsulated in ICMP response packets to rapidly and accurately match requests and responses.

In one example, the method includes generating, by a source node, a plurality of probe request packets, the probe request packets being addressed to a destination node and being associated with an entropy value that identifies as packet flow and including, in each of the probe request packets, a signature value that is unique to the probe request packet within the packet flow. The method further includes setting TTL values in the probe request packets for the packet flow to incrementally increasing values. The method further includes transmitting the probe request packets to a next-hop node in the network topology where transmitting the probe request packets includes, for a first packet flow, transmitting a first probe request packet having a first TTL value and, prior to receiving a probe response packet corresponding to the first probe request packet, transmitting, for the first packet flow, a second probe request packet having a second TTL value different from the first TTL value. The method further includes receiving, by the source node, probe response packets in response to the probe request packets, the probe response packets each encapsulating one of the probe request packets, including the signature value. The method further includes reading, by the source node and from the probe response packets, the signature values. The method further includes determining, by the source node and using the signature values read from the probe response packets, a topology of hops including positions of the hops in a path from the source node to the destination node.

In another example, if there are “n” hosts, which may or may not exist physically behind a router and a network operator wants to perform traceroute from one or more of such hosts, the solution described herein can perform traceroute from the router using a test system or test tool resident on the router or separate from the router and handle the requests and responses (on behalf of hosts) at the router. In one example, the test system performs the associated packet processing of the traceroute requests and responses without relying on the networking stack of the operating system (OS) running on the router or the hosts from which network topology is being discovered. The test system crafts probe packets and inserts unique signatures, etc. On the receive side, the test system processes the incoming packets, bypassing the network stack of the OS running on the router or the hosts. In this way, the test system is not dependent on the existence of physical hosts. The new traceroute operation takes the IP addresses of the hosts from which network topology discovery is desired as input, but does not require there to be an associated real, physical host(s). On receiving the response, the test system checks to determine if it had generated the probe request for the received response and processes the response accordingly. It will be appreciated that the new traceroute topology mapping technique described here is particularly useful when applied to large scale networking environments, such as cloud data centers, etc.

According to another aspect of the subject matter described herein, generating the probe request packets includes generating ICMP packets.

According to another aspect of the subject matter described herein, the method for network topology discovery using enhanced traceroute includes generating the entropy value from a combination of source Internet protocol (IP) address, source UDP port, destination IP address, and destination UDP port.

According to another aspect of the subject matter described herein, the method for network topology discovery using the enhanced traceroute procedure includes varying the entropy values in different ones of the probe request packets to generate probe request packets associated with different packet flows.

According to another aspect of the subject matter described herein, varying the entropy values includes varying source and destination UDP port values used to generate the entropy values.

According to another aspect of the subject matter described herein, including the signature value in each of the probe request packets comprises inserting the signature value in a UDP payload of each of the probe request packets.

According to another aspect of the subject matter described herein, determining the topology of hops in the path includes storing, by the source node and in a network topology database, the signature values and the time to live values of each of the probe request packets, using the signature values read from the probe response packets to locate corresponding records in the network topology database, reading the time to live values from the records in the network topology database, and determining hop positions of originators of the probe response packets using the time to live values read from the records in the network topology database.

According to another aspect of the subject matter described herein, the method for network topology discovery using the enhanced traceroute procedure includes generating a report indicating a number of paths between a source and a destination, IP addresses and hop indices for the hops in each path, entropy values for flows that use each path, and a roundtrip time for each of the hops.

According to another aspect of the subject matter described herein, the source node comprises a network endpoint or a test tool and wherein generating the probe request packets includes generating the probe request packets from a plurality of different Internet protocol addresses.

According to another aspect of the subject matter described herein, the source node comprises a router.

According to another aspect of the subject matter described herein, a system for discovering network paths using an enhanced traceroute procedure is provided. The system includes a source node including at least one processor and a memory. The system further includes a network topology discoverer implemented by the at least one processor for generating a plurality of probe request packets, the probe request packets being addressed to a destination node and each being associated with an entropy value, the network topology discoverer for including, in each of the probe request packets, a signature value that is unique to the probe request packet within the packet flow, setting TTL values in the probe request packets for the packet flow to incrementally increasing values, transmitting the probe request packets to a next-hop node in the network topology, receiving, by the source node, probe response packets in response to the probe request packets, the probe response packets each encapsulating one of the probe request packets, including the signature value, reading, by the source node and from the probe response packets, the signature values, and determining, by the source node and using the signature values read from the probe response packets, a topology of hops including positions of the hops in a path from the source node to the destination node. The network topology discoverer is configured to, in transmitting the probe request packets, for a first packet flow, transmit a first probe request packet having a first TTL value and, prior to receiving a probe response packet corresponding to the first probe request packet, transmit, for the first packet flow, a second probe request packet having a second TTL value different from the first TTL value.

According to another aspect of the subject matter described herein, the network topology discoverer is configured to generate the entropy value from a combination of source IP address, source UDP port, destination IP address, and destination UDP port.

According to another aspect of the subject matter described herein, the network topology discoverer is configured to vary the entropy values in different ones of the probe request packets to generate probe request packets associated with different packet flows.

According to another aspect of the subject matter described herein, the network topology discoverer is configured to vary the entropy values by varying source and destination UDP port values used to generate the entropy values.

According to another aspect of the subject matter described herein, the network topology discoverer is configured to insert the signature value in a UDP payload of each of the probe request packets.

According to another aspect of the subject matter described herein, the network topology discoverer is configured to determine the topology of hops in the path by storing, in a network topology database, the signature values and the time to live values of each of the probe request packets, using the signature values read from the probe response packets to locate corresponding records in the network topology database, reading the time to live values from the records in the network topology database, determining hop positions of originators of the probe response packets using the time to live values read from the records in the network topology database.

According to another aspect of the subject matter described herein, the network topology discoverer is configured to generate a report indicating a number of paths between a source and a destination, IP addresses and hop indices for the hops in each path, entropy values for flows that use each path, and a roundtrip time for each of the hops.

According to another aspect of the subject matter described herein, a non-transitory computer readable medium having stored thereon executable instructions that when executed by a processor of a computer control the computer to perform steps is provided. The steps include generating, by a source node, a plurality of probe request packets, the probe request packets being addressed to a destination node and each being associated with an entropy value that identifies a packet flow and including, in each of the probe request packets, a signature value that is unique to the probe request packet within the packet flow. The steps further include setting TTL values in the probe request packets for the packet flow to incrementally increasing values. The steps further include transmitting the probe request packets to a next-hop node in the network topology, where transmitting the probe request packets, includes, for a first packet flow, transmitting a first probe request packet having a first TTL value and, prior to receiving a probe response packet corresponding to the first probe request packet, transmitting, for the first packet flow, a second probe request packet having a second TTL value different from the first TTL value. The steps further include receiving, by the source node, probe response packets in response to the probe request packets, the probe response packets each encapsulating one of the probe request packets, including the signature value. The steps further include reading, by the source node and from the probe response packets, the signature values. The steps further include determining, by the source node and using the signature values read from the probe response packets, a topology of hops including positions of the hops in a path from the source node to the destination node.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a network diagram illustrating an exemplary network topology for which network topology discovery may be performed;

FIG. 2 is a computer screen shot of a probe request packet that includes a signature for pairing the probe request packet with a probe response packet;

FIG. 3 is a computer screen shot of a probe response packet including a signature from a corresponding probe request packet;

FIG. 4 is a block diagram illustrating an exemplary architecture for an ICMP source node for discovery network paths; and

FIG. 5 is a flow chart illustrating an exemplary process for network topology discovery using enhanced traceroute.

### DETAILED DESCRIPTION

Network topology (real and virtual) is growing and becoming increasingly complex. Debugging and isolating problems in network topologies is a huge task. The introduction of automation in troubleshooting is now a fundamental step. Traceroute is one of the utilities for debugging a network topology. Traditional traceroute can detect hops in a path between a source and a destination, but traceroute cannot detect paths that may exist between a source and a destination. The subject matter described herein includes techniques to detect paths between a source and a destination along with other hop details and display the results in a well-articulated way. The examples described herein illustrate the extension of traceroute for IPv6.

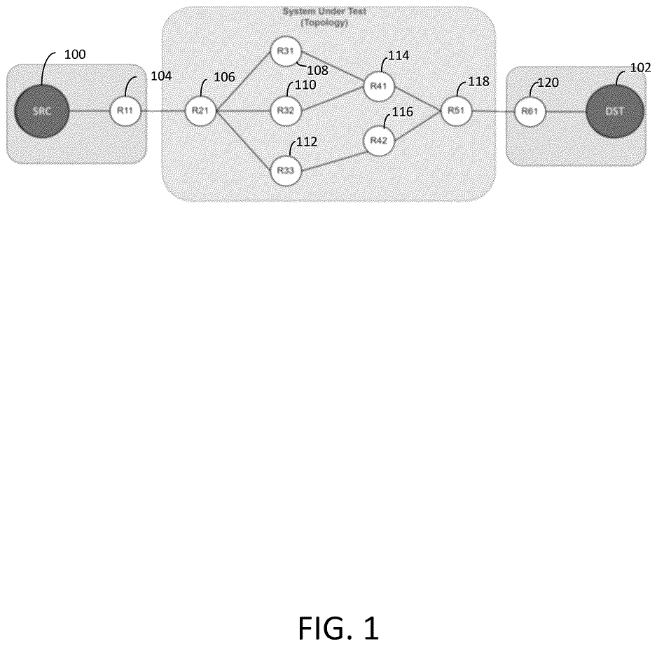

FIG. 1 is a network topology diagram illustrating a sample topology to illustrate the techniques described herein. For a topology such as the topology illustrated in FIG. 1, it may be desirable to discover all possible ECMP paths between a source 100 and a destination 102. In the illustrated example, routers 104-120 form three different ICMP paths between source 100 and destination 102. Each router 104-120 may be a physical router or a virtual router. Although three paths are illustrated in FIG. 1, there may be any number of paths between source 100 and destination 102.

In FIG. 1, the following paths exist between source 100 and destination 102:
Path1->R11---R21---R31---R41---R51---R61
Path2->R11---R21---R32---R41---R51---R61
Path3->R11---R21---R33---R42---R51---R61
   In a large data center environment, it may be desirable to predictively determine the number of available paths between any pair of source and destination nodes.

The subject matter described herein addresses the issue by enhancing traditional traceroute to make it ready for the data center era. If traditional traceroute is run between R11 and R61, the results would appear as follows:
R11→R61
   Hop1(R21)
   Hop2(R31, R32, R33)
   Hop3(R41, R42)
   Hop3(R51)
   Hop3(R61)

It can be seen from the results above that conventional traceroute provides results indicating how many hops each router is from the source. However, conventional traceroute does not provide information as to how the routers at each hop level are connected to the routers at other hop levels. For example, the results above do not indicate how R31, R32, and R33 are connected to R41 and R42. As a result, critical multi-path connectivity information is missing. This was not a problem for traditional networks where there was only a single path between a source and a destination pair. However, modern AI 5 data centers are always multipath, and the traceroute tool requires extension to be useful in such environments.

The subject matter described herein provides topology details, such as possible ECMP path information along with hop information, including round trip time (RTT), as will now be described.

### Exemplary Problem Addressed

In a network topology, any node/link may fail for various reasons. The network operator needs to have an efficient way to debug and isolate failed nodes/links. Traceroute is one way to debug and isolate the faulty node/link. However, existing traceroute is not suitable for finding problems in today's complex multipath networks. The subject matter described herein helps network operators to debug and finding root cause of any network failure in complex multipath network deployments.

### Solution Details

To provide more network topology information than provided by conventional traceroute, the subject matter described herein includes adding a unique per request signature value to probe request packets, maintaining a database record for each probe request packet, including the signatures, and using the signature to match a probe response packet with a particular probe request packet so that connectivities between routers located at different hop levels can be determined. Using to topology in FIG. 1 as an example, router R11 106 may generate an IPv6 traceroute probe request packet (IPv6/UDP) for each hop per flow. A flow is defined by packets that have the same combination of source IP address, source user datagram protocol (UDP) port, destination IP address, and destination UDP port. The combination of source IP address, source UDP port, destination IP address, and destination UDP port can be used as a flow identifier. Packets with the same flow identifiers may be transmitted along the same path between a source and a destination. Packets with different flow identifiers may be transmitted along different paths between a source and a destination. Thus, using a higher number of flows increases the probability of discovering more paths. To identify all the paths in between two nodes, such as source 100 and destination 102, router R11 104 may generate the following probe packets. We are considering only 3 flows for illustration:

TABLE 1
Example Probe Requests

| SRC | DST | Entropy | Hop1 | Hop2 | Hop3 | Hop4 | Hop5 | Hop6 |
|---|---|---|---|---|---|---|---|---|
| SRC | DST | Entropy1 = | TTL = 1 | TTL = 2 | TTL = 3 | TTL = 4 | TTL = 5 | TTL = 6 |
| | | <Flow-id-1> | | | | | | |
| | | Entropy2 = | TTL = 1 | TTL = 2 | TTL = 3 | TTL = 4 | TTL = 5 | TTL = 6 |
| | | <Flow-id-1> | | | | | | |
| | | Entropy3 = | TTL = 1 | TTL = 2 | TTL = 3 | TTL = 4 | TTL = 5 | TTL = 6 |
| | | <Flow-id-3> | | | | | | |

In Table 1, each row corresponds to a series of probe requests with the same flow identifier but incrementally increasing time to live values. For example, the first row after the header indicates that for Flow-id-1, probe request packets with TTL values ranging from 1-6 may be generated

Router R11 104 may maintain, in a network topology database, records including parameters from each of the probe request packets so that router R11 104 can map the responses received from each hop for a particular flow to the intended probe request, but, as will be described in more detail below, if the probe request packets for a given flow are sent prior to receiving probe response packets to previous probe request packets for the same flow, the source node will not be able to map probe response packets to probe request packets. The following are sample responses for the above requests:

TABLE 2
Example Response Content

| Inner | Inner | | | | | | | |
|---|---|---|---|---|---|---|---|---|
| SRC IP | DST IP | Entropy | Hop1? | Hop2? | Hop3? | Hop4? | Hop5? | Hop6? |
| src | dst | Entropy1 = | TTL = 1 | TTL = 2 | TTL = 3 | TTL = 4 | TTL = 5 | TTL = 6 |
| | | <Flow-id-1> | S1, H1 | S1, H2 | S1, H3 | S1, H4 | S1, H5) | (S1, H6 |
| | | | (requester?) | (requester?) | (requester?) | (requester?) | (requester?) | (requester?) |
| | | Entropy2= | TTL = 1 | TTL = 2 | TTL = 3 | TTL = 4 | TTL = 5 | TTL = 6 |
| | | <Flow-id-1> | S1, H1 | S1, H2 | S1, H3 | S1, H4 | S1, H5) | (S1, H6 |
| | | | (requester?) | (requester?) | (requester?) | (requester?) | (requester?) | (requester?) |
| | | Entropy3= | TTL = 1 | TTL = 2 | TTL = 3 | TTL = 4 | TTL = 5 | TTL = 6 |
| | | <Flow-id-3> | S1, H1 | S1, H2 | S1, H3 | S1, H4 | S1, H5) | (S1, H6 |
| | | | (requester?) | (requester?) | (requester?) | (requester?) | (requester?) | (requester?) |

In Table 2, H*->represents the IP address of the hop responding to a probe request. S1->represents the source IP address of the original probe request. Entropy->represents the flow identifier. The entropy value is a tuple of {source IP address, destination IP address, source UDP port, destination UDP port}. All routers decide their next hop based on a hash value, which is calculated from this entropy value. The same hash value is generated for the same entropy value, and hence packets with same entropy value are forwarded to the same next hop, i.e., the same path.

When a node responds to a probe request, the node encapsulates the original probe request packet within the ICMP response packet. For IPv6, the node encapsulates the entire probe request in the ICMP probe response packet. Router R11 104 extracts the original source IP address (S1), destination IP address (D1) and other entropy parameters (UDP source/destination ports) from the received response and maps the probe response to a flow that router R11 104 sent. The TTL value in an encapsulated probe response is always 1 because when a node forwards the probe request, it decreases TTL by 1. A probe response is generated when TTL in probe request is either 1 or when probe request has reached the destination (DST).

One challenge with this process is to map the received probe response from a specific hop to the probe request for that hop or, in other words, to the requester of the response. Because the TTL values of received probe response packets are all equal to 1, if the source has multiple probe request packets in flight or outstanding for a given flow, the source will not be able to match probe request packets with probe response packets. One possible solution is to transmit a probe request packet for a given flow and wait for a probe response packet before transmitting the next probe request packet for the flow. However, such a serial implementation may result in unacceptable delays in network topology discovery for large networks. To solve this problem, the subject matter described herein introduces a unique signature into the packet. In one example, the signature is a 2 byte field and is inserted into the beginning of the UDP payload, which ensures that this unique signature will be echoed back to the requester in an encapsulated ICMP packet, thus allowing multiple probe request packets to be simultaneously in flight or outstanding for a given flow and reducing the time required to discover a network topology over serial traceroute implementations.

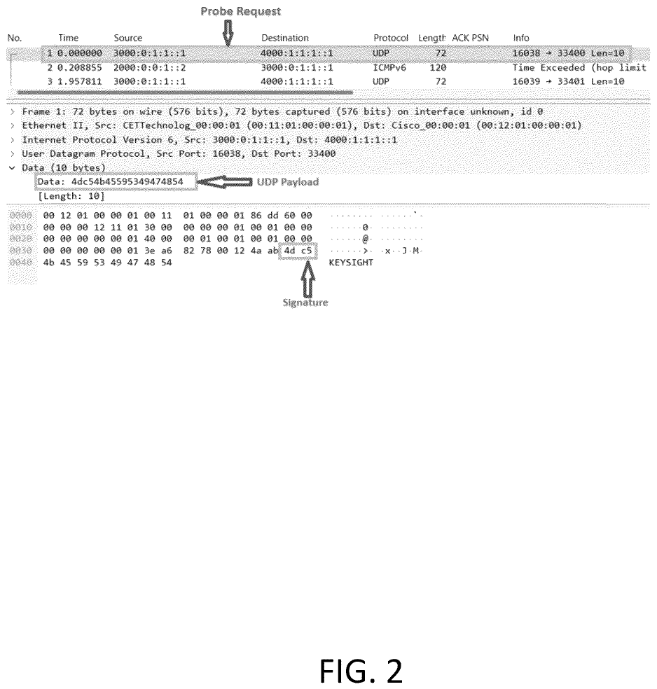

FIG. 2 illustrates an example of a probe request packet with signature. In FIG. 2, the probe request packet is a UDP packet. The UDP packet includes a header and a payload. The header identifies the UDP packet as an ICMPv6 packet. The first 2 bytes of the payload include the value 0x4dc5, which is the signature value.

Accordingly, when a source node seeks to discover all possible paths between a source and a destination, the source may insert unique per-request, per-flow signature in each ICMP request message. The revised probe request messages will appear as follows:

TABLE 3
Revised Probe Request Content

| SRC | DST | Entropy | Hop1 | Hop2 | Hop3 | Hop4 | Hop5 | Hop6 |
|---|---|---|---|---|---|---|---|---|
| SRC | DST | Entropy1 = | TTL = 1 | TTL = 2 | TTL = 3 | TTL = 4 | TTL = 5 | TTL = 6 |
| | | <Flow-id-1> | Sig = 11 | Sig = 12 | Sig = 13 | Sig = 14 | Sig = 15 | Sig = 16 |
| | | Entropy2 = | TTL = 1 | TTL = 2 | TTL = 3 | TTL = 4 | TTL = 5 | TTL = 6 |
| | | <Flow-id-1> | Sig = 21 | Sig = 22 | Sig = 23 | Sig = 24 | Sig = 25 | Sig = 26 |
| | | Entropy3 = | TTL = 1 | TTL = 2 | TTL = 3 | TTL = 4 | TTL = 5 | TTL = 6 |
| | | <Flow-id-3> | Sig = 31 | Sig = 32 | Sig = 33 | Sig = 34 | Sig = 35 | Sig = 36 |

In Table 3, the value following “Sig” is the unique signature, which may be generated programmatically so that the value is unique for each hop per flow.

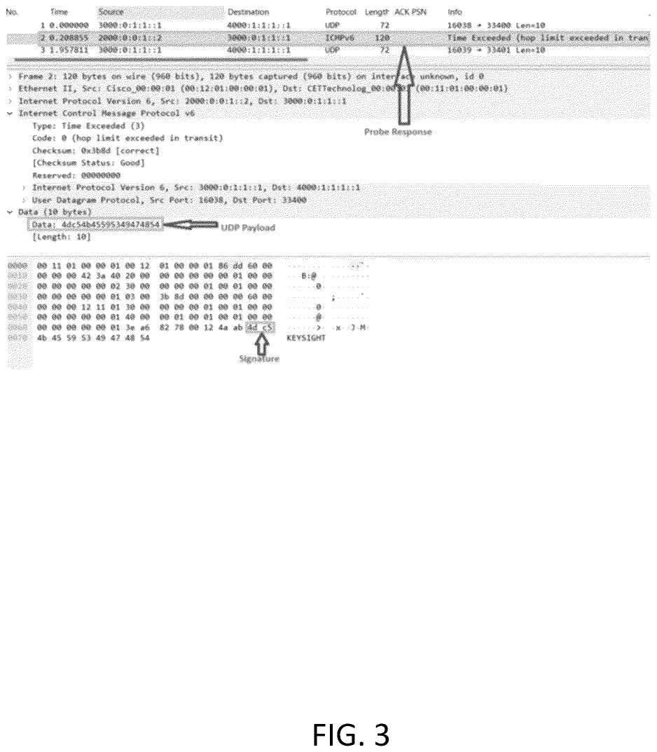

FIG. 3 illustrates the corresponding probe response of the probe request illustrated in FIG. 2. In FIG. 3, the response message is an ICMPv6 message that encapsulates the entire ICMP request message as a UDP payload of the ICMP response message. The first 2 bytes of the payload of the encapsulated ICMP request message contain the signature, which allows the sending node to map the ICMP response message to a specific ICMP request message.

Router R11 104 may send ICMP request messages with the signature values illustrated in Table 3. In response, each hop that receives an ICMP request message with TTL=1 generates a corresponding response, encapsulating the request with the unique signature value. Table 4 below illustrates updated probe responses corresponding to the probe requests in Table 3.

TABLE 4
Example Response Content for Updated Requests

| SRC | DST | Entropy | Hop1 | Hop2 | Hop3 | Hop4 | Hop5 | Hop6 |
|---|---|---|---|---|---|---|---|---|
| SRC | DST | Entropy1 = | TTL = 1 | TTL = 2 | TTL = 3 | TTL = 4 | TTL = 5 | TTL = 6 |
| | | <Flow-id-1> | S1, H1 | S1, H2 | S1, H3 | S1, H4 | S1, H5 | S1, H6 |
| | | | Sig = 11 | Sig = 12 | Sig = 13 | Sig = 14 | Sig = 15 | Sig = 16 |
| | | | (Hop1) | (Hop2) | (Hop3) | (Hop4) | (Hop5) | (Hop6) |
| | | Entropy2 = | TTL = 1 | TTL = 2 | TTL = 3 | TTL = 4 | TTL = 5 | TTL = 6 |
| | | <Flow-id-1> | S1, H1 | S1, H2 | S1, H3 | S1, H4 | S1, H5 | S1, H6 |
| | | | Sig = 21 | Sig = 22 | Sig = 23 | Sig = 24 | Sig = 25 | Sig = 26 |
| | | | (Hop1) | (Hop2) | (Hop3) | (Hop4) | (Hop5) | (Hop6) |
| | | Entropy3 = | TTL = 1 | TTL = 2 | TTL = 3 | TTL = 4 | TTL = 5 | TTL = 6 |
| | | <Flow-id-3> | S1, H1 | S1, H2 | S1, H3 | S1, H4 | S1, H5 | S1, H6 |
| | | | Sig = 31 | Sig = 32 | Sig = 33 | Sig = 34 | Sig = 35 | Sig = 36 |
| | | | (Hop1) | (Hop2) | (Hop3) | (Hop4) | (Hop5) | (Hop6) |

Using the information gathered in Table 4, a source, such as router R11 104. can derive all ECMP paths from these responses as follows: The source generates at least three flows with three different entropies (flow-ids), i.e., flow-id-1, flow-id-2 and flow-id-3. The following example illustrates how a source, such as router R11 104, finds all hops in order from SRC to DST for flow-id-1.

The source SRC sends:
probe request with TTL 1 and signature 11 for first hop
probe request with TTL 2 and signature 12 for second hop
probe request with TTL 3 and signature 13 for third hop
probe request with TTL 4 and signature 14 for fourth hop
probe request with TTL 5 and signature 15 for fifth hop
probe request with TTL 6 and signature 16 for sixth hop
   The source SRC stores and maintain this probe request information in a network topology database as shown in the Table 3 above. When the source SRC receives a probe response, the source SRC does following:
extracts the flow-id, i.e., entropy (src IP, dst IP, src UDP port, dst UDP (encapsulated) IPv6 packet and finds the entropy value to be flow-id-1.
extracts signature value from inner (encapsulated) packet. This signature value determines the position of the hop in the path. For example, a response with signature value 13 for this flow-id-1 determines that this response is coming from third hop because the database record for the probe request with signature value 13 has a TTL value of 3.

The source SRC updates its database with the information received from responses as shown in Table 4 above. This enhanced traceroute algorithm when used by a network test device and run between multiple sources and destinations allows the requesting node to present network topology results in a very intuitive way to the user, as shown below in Table 5.

TABLE 5
Example Path Information Displayed to User

| | | | Path | | | Flow | | Hop | Hop | |
|---|---|---|---|---|---|---|---|---|---|---|
| Source | Destination | #Paths | Index | Status | #Flows | Entropy | #Hops | Index | IP | RTT(ms) |
| SRC | DST | 3 | 0 | Pass | 1 | 45802/33400 | 6 | 0 | R11 | 1 |
| | | | | | | | | 1 | R21 | 3 |
| | | | | | | | | 2 | R31 | 10 |
| | | | | | | | | 3 | R41 | 4 |
| | | | | | | | | 4 | R51 | 8 |
| | | | | | | | | 5 | R61 | 5 |
| | | | 1 | Pass | 1 | 50598/33401 | 6 | 0 | R11 | 4 |
| | | | | | | | | 1 | R21 | 3 |
| | | | | | | | | 2 | R32 | 2 |
| | | | | | | | | 3 | R41 | 12 |
| | | | | | | | | 4 | R51 | 5 |
| | | | | | | | | 5 | R61 | 6 |
| | | | 2 | Fall | 1 | 38579/32690 | 6 | 0 | R11 | 2 |
| | | | | | | | | 1 | R21 | 8 |
| | | | | | | | | 2 | R33 | 4 |
| | | | | | | | | 3 | R42 | 4 |
| | | | | | | | | 4 | * | * |
| | | | | | | | | 5 | * | * |

In Table 5, three paths are identified between SRC and DST, and the hop index indicating the hop position of each router in each path is indicated. For each hop, a roundtrip value is also stored. The flow entropy values are UDP source and destination port numbers.

### Exemplary System and Method

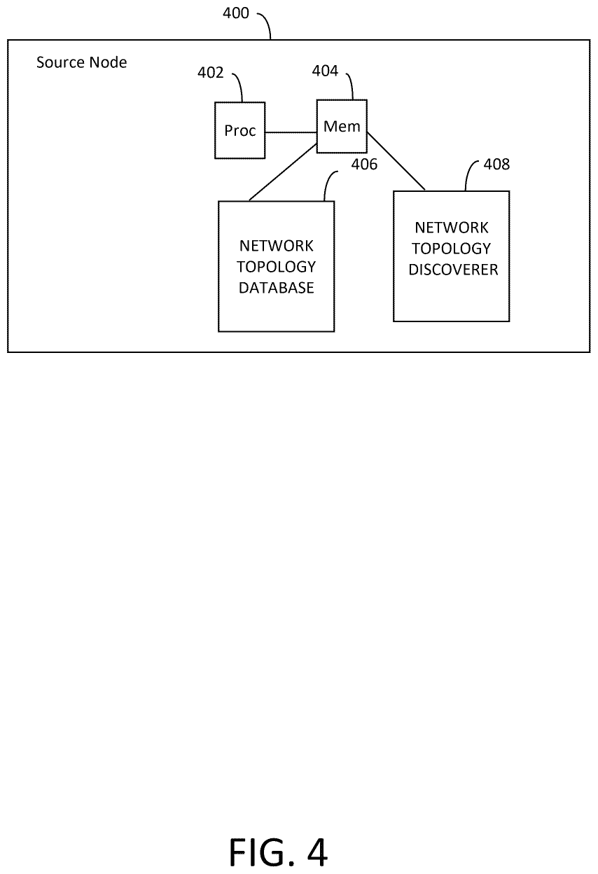

FIG. 4 is a block diagram illustrating an exemplary architecture for an ICMP source node for discovering network paths. Source node 400 may include at least one processor 402 and memory 404. Source node 400 may be any suitable node seeking to discover topology in the network. For example, source node 400 may be a network endpoint, such as a client or a server, a test tool, or an intermediate node, such as a router. As described above, source node 400 may execute the procedures described herein for network topology discovery from a plurality of different IP addresses from which traceroute is desired. The IP addresses may or may not correspond to real or physical hosts. Source node 400 includes a network topology discoverer 406 for performing the steps described herein for discovering the identities of network hops between a source and a destination in a multi-path network topology using the enhanced traceroute procedure described herein. Source node 400 further includes a network topology database 408 that stores information regarding probe request packets that are sent so that network topology discoverer 406 can match signatures in response packets and determine the hop count of the responding node in a path between the source and the destination. Network topology discoverer 406 may be implemented using computer executable instructions stored in memory 404 and executed by processor 402.

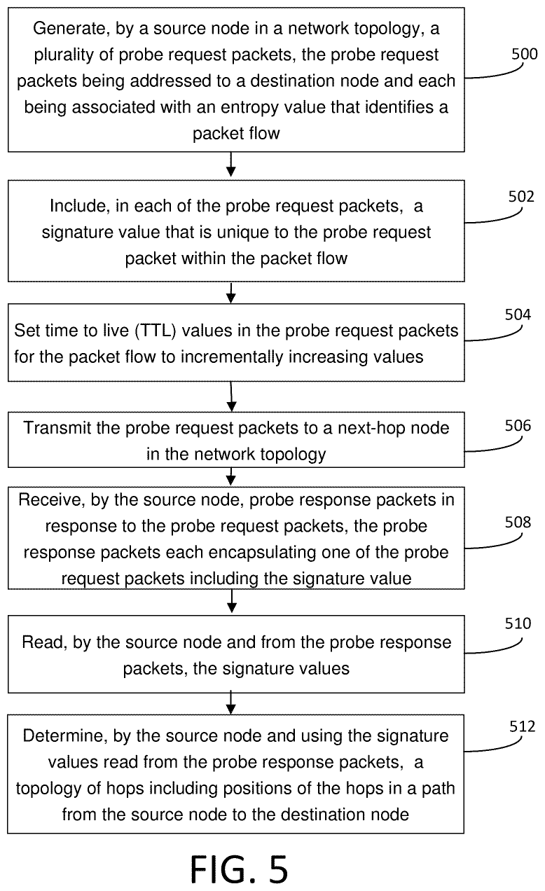

FIG. 5 is a flow chart illustrating an exemplary process for network topology discovery using enhanced traceroute. Referring to FIG. 5, in step 500, the process includes generating, by a source node in a network topology, a plurality of probe request packets, the probe request packets being addressed to a destination node and each being associated with an entropy value that identifies a packet flow. For example, a source node, such as router R11 104, may generate a series of probe request packets for discovering network paths between a source and a destination. The entropy value for each probe request may be a combination of source IP address, source UDP port, destination IP address, and destination UDP port.

In step 502, the process includes, adding to or including in each of the probe request packets, a signature value that is unique to the probe request packet within the packet flow. For example, a source node, such as router R11 104, may include, in each probe request packet, a signature value that is unique to each probe request packet within a given flow.

In step 504, the process includes setting time to live (TTL) values in the probe request packets for the packet flow to incrementally increasing values. For example, a source node, such as router R11 104, may set TTL values in probe packets in each flow to incrementally increasing values to discover multiple hops in each flow.

In step 506, the process includes transmitting the probe request packets to a next-hop node in the network topology. For example, a source node, such as router R11 104, may transmit the first probe request packet for the first flow with TTL=1 and signature S11 to the next hop router. The next hop router may receive the packet, determine that the packet cannot be forwarded, generate a response packet that encapsulates the probe request packet, and transmit the response to the source node. As indicated above, transmitting the probe request packets can include transmitting probe request packets for a given flow so that multiple probe requests packets for the flow can be simultaneously in flight or pending before corresponding probe responses are received, as the unique signature values allow the source node to pair probe response packets with corresponding probe request packets, despite the TTL values in the probe response packets all being equal to the same value of 1.

In step 508, the process includes receiving, by the source node, probe response packets in response to the probe request packets, the probe response packets each encapsulating one of the probe request packets including the signature value. For example, a source node, such as router R11 104 may receive ICMP response packets from routers in different paths between the source node and the destination node.

In step 510, process includes reading, by the source node and from the probe response packets, the signature values. For example, a source node, such as router R11 104 may read the signature value from the ICMP request packet encapsulated by the ICMP response packet.

In step 512, the process includes determining, by the source node and using the signature values read from the probe response packets, a topology of hops including positions of the hops in a path from the source node to the destination node. For example, a source node, such as router R11 104, may use the signature values to perform a lookup in network topology database 408, locate a matching record, read the TTL value from the record, and determine that the node that sent the response message is located at a number of hops away from the source node corresponding to the hop count.

### Benefits

The subject matter described herein is an improvement over the traditional traceroute procedure. Traceroute, with the improvements described herein, can be run simultaneously between many endpoints in any topology and can discover all possible ECMP paths.

Importance Network topologies are becoming increasingly large and complex.

Automation in debugging and troubleshooting is always helpful in terms of time and money. Traceroute with this enhanced capability will help network operators to validate their network topologies easily, effectively and efficiently. The techniques mentioned above would help network operators to achieve their expectations faster because probe requests for a given flow can be sent before responses to previous probe requests for the same flow have been received. In addition, comparing the 2 byte signature with the corresponding values stored in the sender's network topology database provides a rapid and computationally streamlined method for matching probe responses with probe requests. Using signatures also allows probe requests for different ECMP paths to be transmitted in parallel between a given source and destination node and between different pairs of source and destination nodes, further reducing the time required for network topology discovery.

### Overall Ideas

The first idea described herein is inserting unique signature in a control plane packet without changing packet header fields used by intermediate nodes to forward probe requests or responses during the traceroute procedure. The second idea described herein is providing an increased likelihood of discovering all possible ECMP paths in any network topology. The third idea described herein is showing a traceroute result in an intuitive manner to a user in a GUI with pass/fail status.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for discovering network paths using an enhanced traceroute procedure, the method comprising:
generating, by a source node, a plurality of probe request packets, the probe request packets being addressed to a destination node and each being associated with an entropy value that identifies a packet flow;
including, in each of the probe request packets, a signature value that is unique to the probe request packet within the packet flow;
setting time to live (TTL) values in the probe request packets for the packet flow to incrementally increasing values;
transmitting the probe request packets to a next-hop node in the network topology, wherein transmitting the probe request packets includes, for a first packet flow, transmitting a first probe request packet having a first TTL value and, prior to receiving a probe response packet corresponding to the first probe request packet, transmitting, for the first packet flow, a second probe request packet having a second TTL value different from the first TTL value;
receiving, by the source node, probe response packets in response to the probe request packets, the probe response packets each encapsulating one of the probe request packets, including the signature value;
reading, by the source node and from the probe response packets, the signature values; and
determining, by the source node and using the signature values read from the probe response packets, a topology of hops including positions of the hops in a path from the source node to the destination node.

2. The method of claim 1 wherein generating the probe request packets includes generating Internet control management protocol (ICMP) packets.

3. The method of claim 1 comprising generating the entropy value from a combination of source Internet protocol (IP) address, source user datagram protocol (UDP) port, destination IP address, and destination UDP port.

4. The method of claim 3 comprising varying the entropy values associated with different ones of the probe request packets to generate probe request packets associated with different packet flows.

5. The method of claim 4 wherein varying the entropy values includes varying source and destination UDP port values in the probe request packets.

6. The method of claim 1 wherein including the signature value in each of the probe request packets comprises inserting the signature value in a user datagram protocol (UDP) payload of each of the probe request packets.

7. The method of claim 1 wherein determining the topology of hops in the path includes:
storing, by the source node and in a network topology database, the signature values and the time to live values of each of the probe request packets;
using the signature values read from the probe response packets to locate corresponding records in the network topology database;
reading the time to live values from the records in the network topology database; and
determining hop positions of originators of the probe response packets using the time to live values read from the records in the network topology database.

8. The method of claim 1 comprising generating a report indicating a number of paths between a source and a destination, IP addresses and hop indices for the hops in each path, entropy values for flows that use each path, and a roundtrip time for each of the hops.

9. The method of claim 1 wherein the source node comprises a network endpoint or a test tool and wherein generating the probe request packets includes generating the probe request packets from a plurality of different Internet protocol addresses.

10. The method of claim 1 wherein the source node comprises a router.

11. A system for discovering network paths using an enhanced traceroute procedure, the system comprising:
a source node including at least one processor and a memory; and
a network topology discoverer implemented by the at least one processor for generating a plurality of probe request packets, the probe request packets being addressed to a destination node and each being associated with an entropy value that identifies a packet flow, the network topology discoverer for including, in each of the probe request packets, a signature value that is unique to the probe request packet within the packet flow, setting time to live (TTL) values in the probe request packets for the packet flow to incrementally increasing values, transmitting the probe request packets to a next-hop node in the network topology, receiving, by the source node, probe response packets in response to the probe request packets, the probe response packets each encapsulating one of the probe request packets, including the signature value, reading, by the source node and from the probe response packets, the signature values, and determining, by the source node and using the signature values read from the probe response packets, a topology of hops including positions of the hops in a path from the source node to the destination node, wherein the network topology discoverer is configured to, in transmitting the probe request packets, for a first packet flow, transmit a first probe request packet having a first TTL value and, prior to receiving a probe response packet corresponding to the first probe request packet, transmit, for the first packet flow, a second probe request packet having a second TTL value different from the first TTL value.

12. The system of claim 11 wherein the probe request packets comprise Internet control management protocol (ICMP) packets.

13. The system of claim 11 wherein the network topology discoverer is configured to generate the entropy value from a combination of source Internet protocol (IP) address, source user datagram protocol (UDP) port, destination IP address, and destination UDP port.

14. The system of claim 13 wherein the network topology discoverer is configured to vary the entropy values associated with different ones of the probe request packets to generate probe request packets associated with different packet flows.

15. The system of claim 14 wherein the network topology discoverer is configured to vary the entropy values by varying source and destination UDP port values in the probe request packets.

16. The system of claim 11 wherein the network topology discoverer is configured to insert the signature value in a user datagram protocol (UDP) payload of each of the probe request packets.

17. The system of claim 11 wherein the network topology discoverer is configured to determine the topology of hops in the path by:
storing, in a network topology database, the signature values and the time to live values of each of the probe request packets;
using the signature values read from the probe response packets to locate corresponding records in the network topology database;
reading the time to live values from the records in the network topology database; and
determining hop positions of originators of the probe response packets using the time to live values read from the records in the network topology database.

18. The system of claim 11 wherein the network topology discoverer is configured to generate a report indicating a number of paths between a source and a destination, IP addresses and hop indices for the hops in each path, entropy values for flows that use each path, and a roundtrip time for each of the hops.

19. The system of claim 11 wherein the source node comprises a network endpoint, a test tool, or a router and wherein generating the probe request packets includes generating the probe request packets from a plurality of different Internet protocol addresses.

20. A non-transitory computer readable medium having stored thereon executable instructions that when executed by a processor of a computer control the computer to perform steps comprising:
generating, by a source node in a network topology, a plurality of probe request packets, the probe request packets being addressed to a destination node and each being associated with an entropy value identifying a packet flow;
including, in each of the probe request packets, an entropy value that is unique to a packet flow and a signature value that is unique to the probe request packet within the packet flow;
setting time to live (TTL) values in the probe request packets for the packet flow to incrementally increasing values;
transmitting the probe request packets to a next-hop node in the network topology, wherein transmitting the probe request packets includes, for a first packet flow, transmitting a first probe request packet having a first TTL value and, prior to receiving a probe response packet corresponding to the first probe request packet, transmitting, for the first packet flow, a second probe request packet having a second TTL value different from the first TTL value;
receiving, by the source node, probe response packets in response to the probe request packets, the probe response packets each encapsulating one of the probe request packets, including the signature value;
reading, by the source node and from the probe response packets, the signature values; and
determining, by the source node and using the signature values read from the probe response packets, a topology of hops including positions of the hops in a path from the source node to the destination node.
